(19) United States
(12) Patent Application Publication
(10) Pub. No.: US 2007/0059213 A1
(43) Pub. Date: Mar. 15, 2007

(54) Heat-induced transitions on a structured surface

(75) Inventors: Joanna Aizenberg, New Providence, NJ (US); Marc Scott Hodes, New Providence, NJ (US); Paul Robert Kolodner, Hoboken, NJ (US); Thomas Nikita Krupenkin, Warren, NJ (US); Joseph Ashley Taylor, Springfield, NJ (US)

Correspondence Address: HITT GAINES, PC;LUCENT TECHNOLOGIES INC., PO BOX 832570, RICHARDSON, TX, 75083, US

(73) Assignee: Lucent Technologies Inc., Murray Hill, NJ (US)

(21) Appl. No.: 11/227,808

(22) Filed: Sep. 15, 2005

(51) Int. Cl. B01L 3/00

(52) U.S. Cl. 422/99

(57) ABSTRACT

A device comprising a substrate having a base layer, the base layer being connectable to a source of current. The device also includes fluid-support-structures located on the base layer. Each of the fluid-support-structures has at least one dimension of about 1 millimeter or less. The base layer is configured to impart heat to a fluid locatable over the base layer and convert at least a portion of the fluid to a vapor when a current is applied to the base layer.

### TECHNICAL FIELD OF THE INVENTION

The present invention is directed, in general, to a device and method for changing the vertical location of a fluid on a structured surface of the device.

### BACKGROUND OF THE INVENTION

One problem encountered when handling small fluid volumes is to wet and de-wet a surface. Transitioning between a wet and a non-wet surface allows one to control properties of the fluid-solid interface, such as the mobility of a fluid on a surface. Controlling the mobility of a fluid on a surface is advantageous in analytical applications where it is desirable to repeatedly move a fluid to a designated location, immobilize the fluid and remobilize it again. Unfortunately, existing surfaces do not provide adequate reversible control of wetting and de-wetting.

For instance, certain surfaces with raised features, such as posts or pins, may provide so-called superhydrophobic surfaces that strongly inhibit wetting. For example, a droplet of liquid on such superhydrophobic surfaces can appear as a suspended drop having a contact angle of at least about 140 degrees. Applying a voltage between the surface and the droplet can cause the surface to become wetted, as indicated by the suspended drop having a contact angle of less than 90 degrees. This is further discussed in U.S. Patent Applications 2005/0039661 and 2004/0191127, which are incorporated by reference herein in their entirety. Unfortunately, the droplet may not return to its position on top of the structure, with its previous high contact angle, when the voltage is then turned off.

Another problem encountered when handling small fluid volumes is to effectively mix fluids together. Poor mixing can occur in channel-based microfluidic devices, where two or more volumes of different fluids, each flowing through microchannels, are combined together at a junction and into a single channel. In some cases, poor mixing can be ameliorated by introducing flow diverters into the junction or the single channel to redirect the flow of the two fluids to facilitate better mixing. However, flow diverters are complex structures that are technically difficult to construct. Additionally, channels having flow diverters are prone to being clogged by particles suspended in the fluid.

Poor mixing can also occur in droplet-based microfluidic devices, where the fluids are not confined in channels. Instead, small droplets of fluid (e.g., fluid volumes of about 100 microliters or less) are moved and mixed together on a planar surface. In some cases, it is desirable to add as small a volume of a reagent as possible to facilitate the analysis of a small volume of a fluid sample, without substantially diluting the sample. In such cases, there is limited ability to mix two droplets together because there is no flow of fluids to facilitate mixing. Additionally, because there is no flow of fluids, it is not possible to facilitate mixing with the use of flow diverters.

Embodiments of the present invention overcome these problems by providing a device that has a surface that can be reversibly wetted and de-wetted and that can facilitate mixing of small volumes of fluids, as well as providing methods of using and making such a device.

### SUMMARY OF THE INVENTION

To address the above-discussed deficiencies, one embodiment of the present invention is a device. The device comprises a substrate having a base layer, the base layer being connectable to a source of current. The device also includes fluid-support-structures located on the base layer. Each of the fluid-support-structures has at least one dimension of about 1 millimeter or less. The base layer is configured to impart heat to a fluid locatable over the base layer and convert at least a portion of the fluid to a vapor when a current is applied to the base layer.

Another embodiment is a method of use. The method comprises placing a fluid over a substrate having the above-described base layer and fluid-support-structures. The method also includes raising the fluid to tops of the fluid-support-structures by applying a current through the base layer, thereby converting at least a portion of the fluid to a vapor.

Yet another embodiment comprises a method of manufacturing a device. The method includes removing portions of a substrate to form a base layer and a plurality of the above-described fluid-support-structures thereon. The method also comprises coupling a source of current to the base layer. The source of current is configured to apply a current to the base layer, to thereby convert a portion of a fluid locatable over the base layer into a vapor.

### BRIEF DESCRIPTION OF THE DRAWINGS

The invention is best understood from the following detailed description, when read with the accompanying FIGUREs. Various features may not be drawn to scale and may be arbitrarily increased or reduced in size for clarity of discussion. Reference is now made to the following descriptions taken in conjunction with the accompanying drawings, in which:

FIG. 1 presents a cross-sectional view of an exemplary device of the present invention;

FIG. 2 shows a plan view the device presented in FIG. 1;

FIG. 3 presents a perspective view of sample-support-structures that comprises one or more cell;

FIGS. 4-7 present cross-section views of an exemplary device at various stages of use; and

FIGS. 8-11 present cross-section views of an exemplary device at selected stages of manufacture.

### DETAILED DESCRIPTION

The present invention recognizes, for the first time, that the vertical position of a fluid can be moved from the bottom to the top of certain kinds of fluid-support-structures by converting a portion of the fluid to a vapor. The application of a current through a conductive base layer that the fluid-support-structures are on causes heating of the lower portion of the fluid. The heated portion of the fluid is rapidly vaporized. The vaporized fluid rapidly expands, thereby pushing the non-vaporized portion of fluid to the tops of the fluid-support-structures.

As part of the present invention, it was discovered that moving fluids in this manner facilitates the transition of a surface from a wetted to a non-wetted state. It was further discovered that moving fluids in this manner also facilitates the mixing of fluids. For instance, vertically moving two fluids on the surface as described herein can promote convection in the two fluids, resulting in their mixing.

Each fluid-support-structure can be a nanostructure or microstructure. The term nanostructure as used herein refers to a predefined raised feature on a surface that has at least one dimension that is about 1 micron or less. The term microstructure as used herein refers to a predefined raised feature on a surface that has at least one dimension that is about 1 millimeter or less. The term fluid as used herein refers to any liquid that is locatable on the fluid-support-structure. The term de-wetted surface, as used herein, refers to a surface having fluid-support-structures that can support a droplet of fluid thereon such that the droplet has a contact angle of at least about 140 degrees. The term wetted surface, as used herein, refers to a surface having fluid-support-structures that can support a droplet of fluid thereon such that the droplet has a contact angle of about 90 degrees or less. In some cases, de-wetted implies no contact with a base layer and wetted implies contact with base.

The term superheated fluid, as used herein, refers to a fluid that has been rapidly heated to temperature that is higher than the fluid's initial point of nucleate boiling, without actual boiling. As is well known to those of ordinary skill in the art, a fluid can become superheated when rapidly heated while in an undisturbed state. The term superheat explosion, as used herein, refers to the well-known phenomenon observed when a superheated fluid, upon being disturbed, explodes, that is, gets rapidly converted into a vapor, with a concomitant increase in volume associated with the fluid-to vapor-transition.

The term film boiling, as used herein, refers to a fluid that has been heated to a temperature where a portion of the fluid has been converted to a layer or film of vapor between the fluid and the hot surface that the fluid is on. The temperature at which film boiling occurs can range from the critical heat flux point of the fluid to the Leidenfrost point of the fluid. As is well known to those skilled in the art, the critical heat flux point occurs when the fluid is being heated on a body that has substantially no thermal mass, and hence cannot store most of the energy applied to heat the body. The Leidenfrost point occurs when the fluid is being heated on a body having sufficient thermal mass to absorb a portion of the energy applied to heat the body. One of ordinary skill in the art would be familiar with how to measure the critical heat flux point and Leidenfrost point of a fluid. For example, the critical heat flux point of water is about 130° C., while the Leidenfrost point temperature is about 220° C.

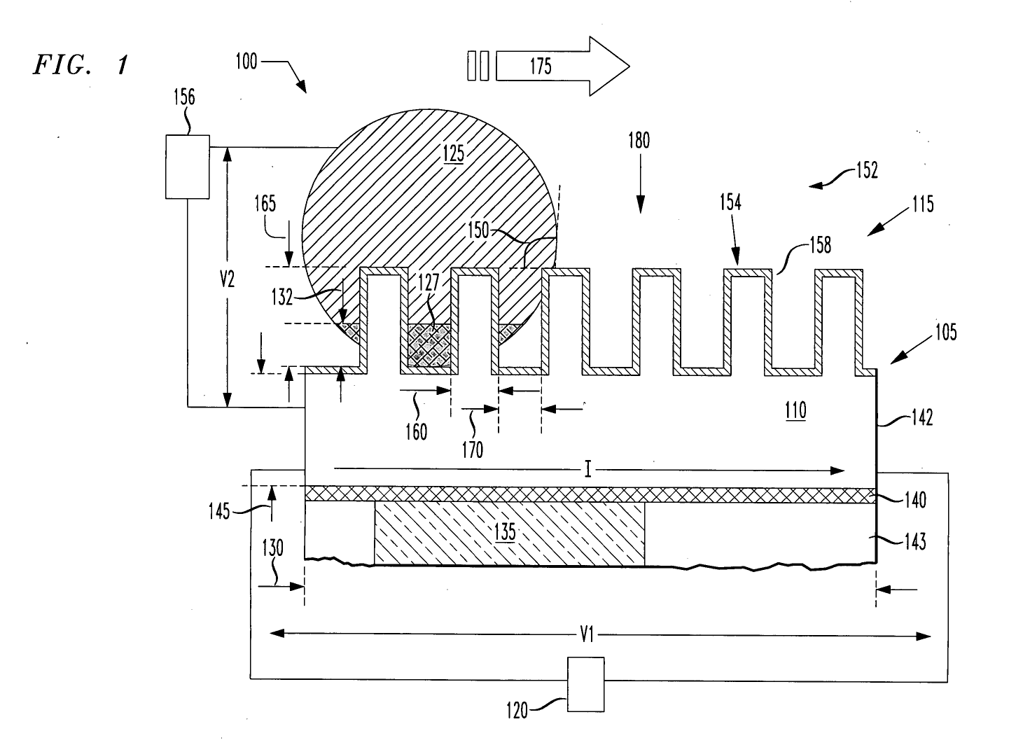

One embodiment of the present invention is a device. Some preferred embodiments of the device comprise a mobile diagnostic device such as a lab-on-chip or microfluidic device. FIG. 1 presents a cross-sectional view of an exemplary device 100 of the present invention.

The device 100 comprises a substrate 105 having a base layer 110. The device 100 also includes fluid-support-structures 115 that are on the base layer 110. Each of the fluid-support-structures 115 has at least one dimension of about 1 millimeter or less, and in some cases, about 1 micron or less. The base layer 110 is connectable to a source of current 120, and is also configured to impart heat to a fluid 125 locatable over the base layer 110. Imparting heat to the fluid 125 converts at least a portion 127 of the fluid 125 to a vapor when a current (I1) is applied to the base layer 110.

The source of current 120 can be a current source or a voltage source. In some cases, for example, the source of current 120 is configured to apply a voltage (V1) across a lateral width of the base layer 110. As shown in FIG. 1, the voltage (V1) from the source of current 120 may be applied across an entire lateral width 130 of the base layer 110. The applied voltage (V1) causes the current (I1) to flow through the base layer 110. Because the base layer 110 has an inherent electrical resistivity, the flow of the current across the lateral width 130 results in heating of the base layer 110. Heat from the base layer 110, in turn, is transferred to a portion of the fluid 127.

The fluid-support-structures 115 can be directly or indirectly heated, thereby assisting in the heating of the fluid 127. For instance, when the fluid-support-structures 115 are electrically coupled to the base layer 110, the current (I1) can also flow through the fluid-support-structures 115, resulting in their direct heating. Also, the fluid-support-structures 115 can be heated indirectly via the conduction of heat from the base layer 110 to the fluid-support-structures 115.

In some cases, it is advantageous for the current (I1) to rapidly heat a portion of the fluid 127 so as to produce a superheat explosion or film boiling. In some cases, the desire to rapidly heat has to be balanced with the desire to convert only a small portion of the fluid 127 into a vapor. Such can be the case when it is important to maintain a constant concentration of a compound in the fluid. Or, it may be important to retain as much of the volume of the fluid as possible, so that the fluid can be later used for analysis or mixing applications. In some preferred embodiments of the device 100, for example, the portion of fluid 127 converted comprises less than about 10 percent, and more preferably, less than about 1 percent, of a total volume of the fluid 125.

The amount of fluid converted into a vapor can be controlled by adjusting the extent and duration of heat applied to the fluid 125. There are several ways that the extent and duration of heat can be adjusted. One way is to control the duration and magnitude of the current (I1) applied to the base layer 110. In some preferred embodiments, for example, when the base layer 110 comprises silicon, the current (I1) comprises a pulse of current of from about 10 to about 200 Amps applied for about 10 to about 100 ms. In other preferred embodiments, a current pulse of about 100 Amps is applied for about 30 to 40 ms. Of course, the duration and magnitude of the current (I1) can be adjusted to different values, in instances where the base layer 110 is composed of a material having an electrical resistivity that is substantially different from silicon.

Preferably, the portion of fluid 127 that is heated and converted to a vapor is proximate to the base layer 110. For instance, in some cases, the portion of the fluid 127 has a vertical thickness 132 above the base layer 110 that ranges from about 200 microns to 2 millimeters. Of course, when the portion of the fluid 127 is superheated or film boiled, it has a temperature that is greater than the fluid's 125 standard boiling point, that is, the temperature at which nucleate boiling commences.

For example, when the fluid 125 comprises water at about 1 atmosphere, the superheated portion of fluid 127 can have a temperature from above 100 to about 300° C. In other cases, where the fluid comprises water at 1 atmosphere of pressure, the film boiled portion of fluid 127 can have a temperature ranging from the critical flux point (about 130° C.) to the Leidenfrost Point (about 200° C.). The rate of temperature increase of the base layer 110 will determine whether the portion of fluid 127 is converted to a vapor due to a superheat explosion, such as when the fluid's temperature increases at about 80E6° K/second (see e.g., Glod et al. Int. J. Heat & Mass Transfer 45 (2002) 367-379, incorporated herein in its entirety), or due to film boiling where a lower rate of temperature increase occurs.

Selecting the material of which the base layer 110 is composed is another way to adjust the extent and duration of heat applied to the fluid 125 through the base layer 110. For instance, the selection of a material having a high thermal conductivity facilitates the temperature of the base layer 110 to decrease rapidly after applying the current (I1). A rapid decrease in temperature in the base layer 110 after applying the current (I1) is desirable in cases where one does not wish to promote evaporation of a substantial portion (e.g., greater than about 10 percent) of the fluid 125. In some embodiments, the base layer 110 has a thermal conductivity in the range of about 150 to about 50 W/m·K at a temperature of from about 100° to about 200° C.

Coupling a heat buffer 135 to the base layer 110 can also help control the extent and duration of heat applied to the fluid 125 through the base layer 110. For instance, a heat buffer 135 having a thermal conductivity that is equal to or greater than that of the base layer 110 will help to speed the reduction in temperature of the base layer 110 after applying the current (I1). In such instances, the heat buffer 135 acts as a heat sink. For example, in some cases, the heat buffer 135 thermally coupled to the base layer 110 has a thermal conductivity that is at least about 50 percent greater than the thermal conductivity of the base layer 110. In other cases, the heat buffer 135 comprises a metal layer having a thermal conductivity ranging from about 400 to about 200 W/m·K, respectively, from about 100° to about 200° C. Examples of suitable metals for the heat buffer 135 include copper or aluminum or alloys thereof. Of course, the thermal conductivity is not the only parameter that affects transient conductive heat transfer and those skilled in the art will recognize that the thermal diffusivity of the material is also important.

In some cases, however, it is desirable to promote the evaporation of the fluid after the applied current (I1). This can be the case when it is advantageous to concentrate a compound that is dissolved in the fluid 125. In such instances, it is preferable for the base layer 110, heat buffer 135, or both, to be composed of materials having a lower thermal conductivity than that cited above. Consider, for example, when the thermal conductivity of the heat buffer 135 is less than the thermal conductivity of the base layer 110. In such instances, the heat buffer 135 is configured to insulate. In this case, the base layer 110 will retain heat for a longer period, as compared to when the heat buffer 135 has a thermal conductivity that is greater than the thermal conductivity of the base layer 110.

In some cases, the heat buffer 135 can comprise a portion of the substrate 105 itself. As an example, the substrate 105 illustrated in FIG. 1 comprises an insulating layer 140 located between an upper conductive layer 142 and a lower conductive layer 143. For instance, the substrate 105 can comprise a planar semiconductor substrate, and more preferably, a silicon-on-insulator (SOI) wafer, where the insulating layer 140 comprises silicon oxide and the upper and lower conductive layers 142, 143 comprise silicon. Of course, in other embodiments, the substrate 105 can comprise a plurality of planar layers made of other types of conventional materials.

In such embodiments, the upper conductive layer 142 can comprise the base layer 110 and fluid-support-structures 115. The insulating layer 140 can be an electrical insulator, a thermal insulator, or both. The latter is the case when the insulating layer 140 comprises silicon oxide. In such embodiments, because the thermal conductivity of silicon oxide is less than that of silicon, the insulating layer 140 acts as a heat insulator, thereby facilitating the retention of heat in the base layer 110. Of course, as further illustrated in FIG. 1, the device 100 can include both an insulating layer 140 and a heat buffer 135 to further adjust the heating or cooling characteristics of the base layer 110.

Still another way to adjust the extent and duration of heat applied to the fluid 125 is to adjust a thickness 145 of the base layer 110. For a given duration and magnitude of current, the thin base layer 110 will heat up and cool down more rapidly than a thick base layer 110. In some preferred embodiments, the base layer 110 comprises silicon having a thickness 145 ranging from about 1 to about 100 microns.

In some preferred embodiments of the device 100, the fluid-support-structures 115 are configured to cooperatively support the fluid 125 so that a droplet of the fluid 125 would form a contact angle 150 of about 140 degrees or higher. In such embodiments, a surface 152 of the device 100 having the fluid-support-structures 115 is de-wettable. Consequently, the fluid 127 rests substantially on tops 154 (e.g., the uppermost 10 percent) of the fluid-support-structures 115. Some preferred embodiments of the device 100 further comprise a source of voltage 156 configured to apply a voltage (V2) between the fluid-support-structures 115 and the fluid 125, thereby decreasing the contact angle 150 to about 90 degrees or less, such as shown in FIG. 1. The application of the voltage (V2) causes the surface 152 to be wetted. When the surface 152 is wetted, the fluid 125 can penetrate the fluid-support-structures 115 and contact the base layer 110.

In some cases, the source of voltage 156 and the source of current 120 are configured to work in cooperation to respectively wet and de-wet the surface 152 of the device 100. For example, the source of voltage 156 can be configured to apply a voltage ranging from about 10 to about 50 volts, alternately with a source of current 120 configured to apply a current (I1) as described above. In some cases, as illustrated in FIG. 1, the sources of current 120 and voltage 156 are separate components of the device 100. Of course, in other embodiments of the device, a single component could be configured to serve as both the source of current and voltage.

In some preferred embodiments of the device 100, each of the fluid-support-structures 115 and the base layer 110 has a coating 158 that comprises an electrical insulator. For example, when the fluid-support-structures 115 and base layer 110 both comprise silicon, the coating 158 can comprise an electrical insulator of silicon oxide. In such embodiments, the coating 158 prevents current from flowing through the base layer 110 or the fluid-support-structures 115 when a voltage (V2) is applied between the fluid-support-structures 115 and the fluid 125 via the voltage source 156.

In other preferred embodiments, it is desirable for the coating 158 to also comprise a low surface energy material. The low surface energy material facilitates obtaining a high contact angle when the fluid 125 is on the fluid-support-structures 115, when no voltage (V2) is applied between the fluid 125 and fluid-support-structures 115. The term low surface energy material, as used herein, refers to a material having a surface energy of about 22 dyne/cm (about 22×10⁻⁵ N/cm) or less. Those of ordinary skill in the art would be familiar with the methods to measure the surface energy of materials.

For instance, the coating 158 can comprise a single material, such as Cytop® (Asahi Glass Company, Limited Corp. Tokyo, Japan), a fluoropolymer that is both an electrical insulator and low surface energy material. In other cases, the coating 158 can comprise separate layers of insulating material and low surface energy material. For example, the coating 158 can comprise a layer of a dielectric material, such as silicon oxide, and a layer of a low-surface-energy material, such as a fluorinated polymer like polytetrafluoroethylene.

In some instances, the fluid-support-structures 115 of the device 100 are laterally separated from each other. For example, the fluid-support-structures 115 depicted in FIG. 1 are post-shaped, and more specifically, cylindrically-shaped posts. The term post as used herein, includes any structures having circular, square, rectangular or other cross-sectional shapes.

Each of the fluid-support-structures 115 is a microstructure or nanostructure. When the fluid-support-structure 115 is a microstructure, it has at least one dimension of about 1 millimeter or less. When the fluid-support-structure 115 is a nanostructure, it has at least one dimension of about 1 micron or less. In some embodiments, the one dimension that is about 1 millimeter or less, or about 1 micron or less, corresponds to a lateral thickness 160 of the fluid-support-structure 115. The lateral thickness 160 corresponds to a diameter of the post when the post has a circular cross-section. In certain preferred embodiments, each of the fluid-support-structures 115 has a uniform height 165. In some embodiments, the height 165 is in the range from about 1 to about 10 microns. In other embodiments, the lateral thickness 160 is about 1 micron or less, and the spacing 170 between the fluid-support-structures 115 ranges from about 1 to about 10 microns. In some preferred embodiments, the lateral thickness 160 ranges from about 0.2 to about 0.4 microns.

In some embodiments of the device 100, the fluid-support-structures 115 have a uniform spacing 170. However, in other cases, the spacing 170 is non-uniform. For instance, in some cases, it is desirable to progressively decrease the spacing 170 between the fluid-support-structures 115 along a direction 175 to a desired location 180 to facilitate the movement of the fluid 125. For example, the spacing 170 can be progressively decreased from about 10 microns to about 1 micron.

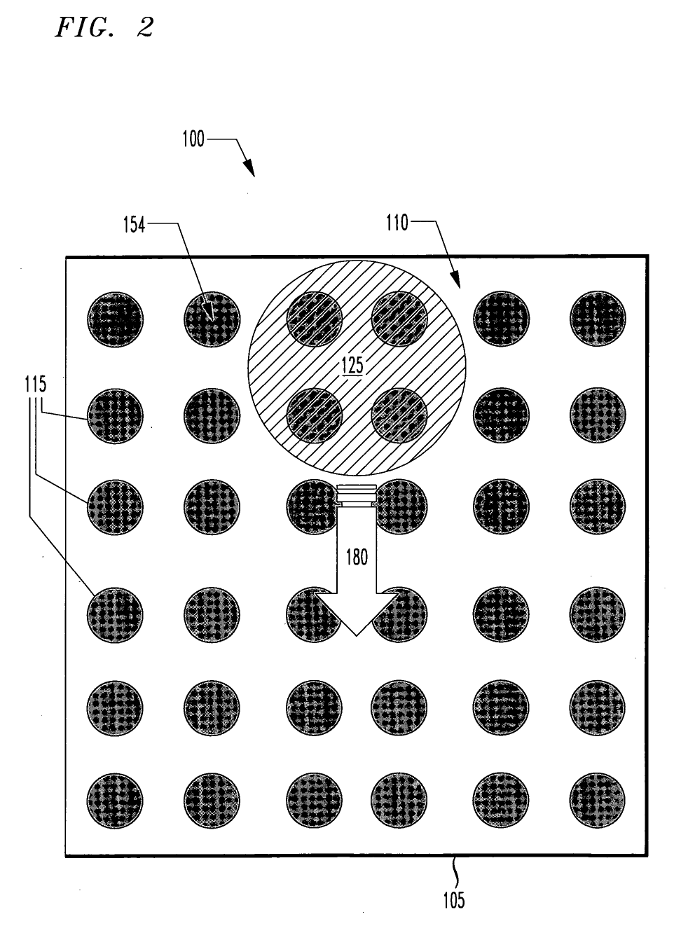

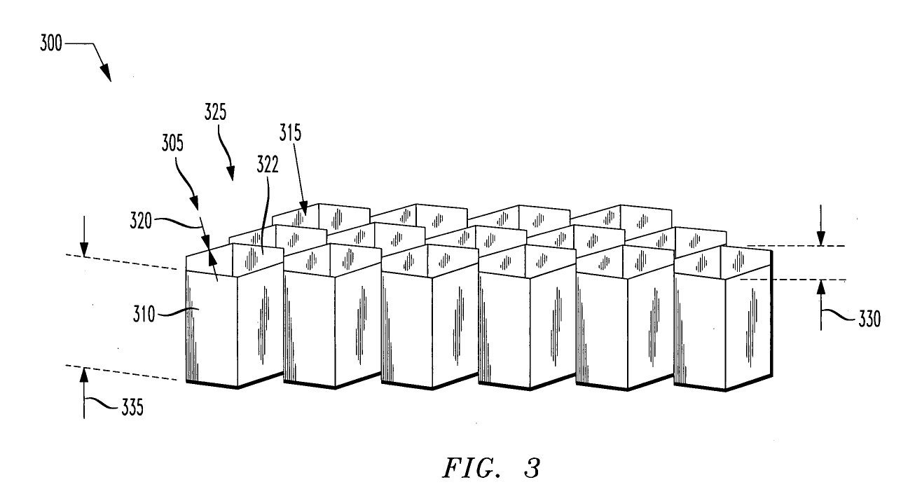

In some cases, it is advantageous to arrange the laterally-separated fluid-support-structures 115 into a two-dimensional array, such as illustrated in the plan view of the device 100 in FIG. 2. In other instances, the fluid-support-structures are laterally connected to each other. For example, FIG. 3 presents a perspective view of fluid-support-structures 300 that comprise one or more cells 305.

The term cell 305, as used herein, refers to a structure having walls 310 that enclose an open area 315 on all sides except for the side over which the fluid could be disposed. In such embodiments, the one dimension that is about 1 micrometer or less is a lateral thickness 320 of walls 310 of the cell 305. As illustrated in FIG. 3, the fluid-support-structures 300 are laterally connected to each other because the cell 305 shares at least one wall 322 with an adjacent cell 325. In certain preferred embodiments, a maximum lateral width 330 of each cell 305 is about 15 microns or less and a maximum height 335 of each cell wall is about 50 microns or less. For the embodiment shown in FIG. 3, each cell 305 has an open area 315 prescribed by a hexagonal shape. However, in other embodiments of the cell 305, the open area 315 can be prescribed by circular, square, octagonal or other shapes.

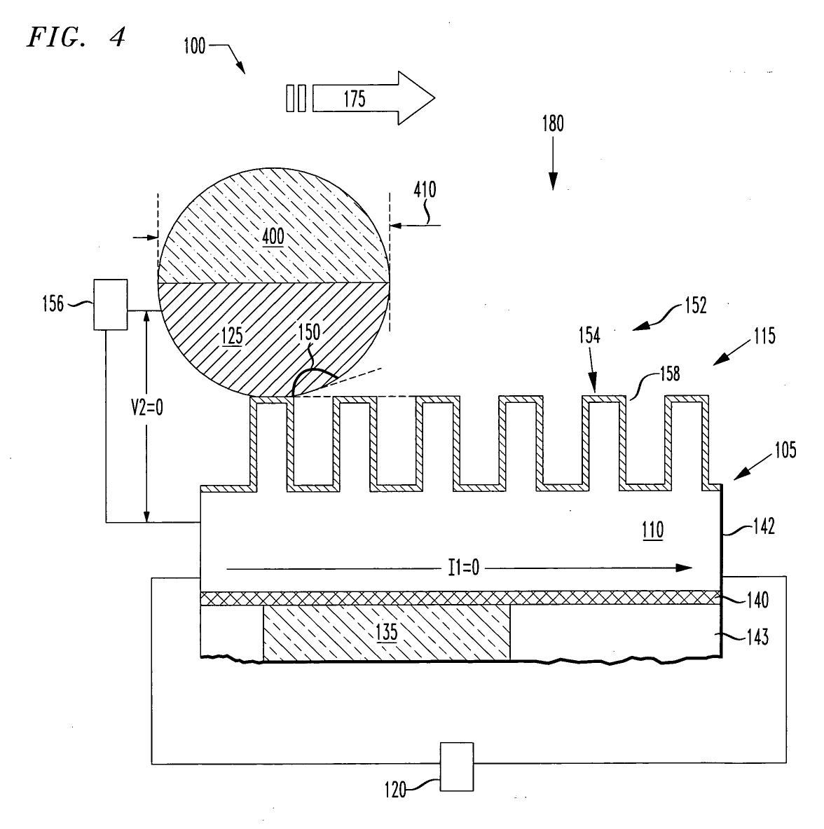

Another embodiment of the present invention is a method of use. FIGS. 4-7 present cross-sectional views of the exemplary device 100 shown in FIG. 1 at various stages of use. FIGS. 4-7 use the same reference numbers to depict analogous structures shown in FIGS. 1-2. However, any of the various embodiments of the devices of the present invention discussed above and illustrated in FIGS. 1-3 could be used in the method.

Turning to FIG. 4, while maintaining reference to FIG. 1, illustrated is the device 100 after placing a fluid 125 on a substrate 105. As with previously discussed device embodiments, the substrate 105 has a base layer 110 and fluid-support-structures 115 located on the base layer 110. The base layer 110 is connectable to a source of current 120, and the fluid-support-structures 115 have at least one dimension of about 1 millimeter or less.

In some cases, as illustrated in FIG. 4, the fluid-support-structures 115, in the absence of an applied voltage (V2=0), is a de-wetted surface 152 that supports the fluid 125 on the tops 154 of the fluid-support-structures 115. Preferably, the contact angle 150 is about 140 degrees or higher. Such a surface is referred to hereinafter as an intrinsically de-wettable surface.

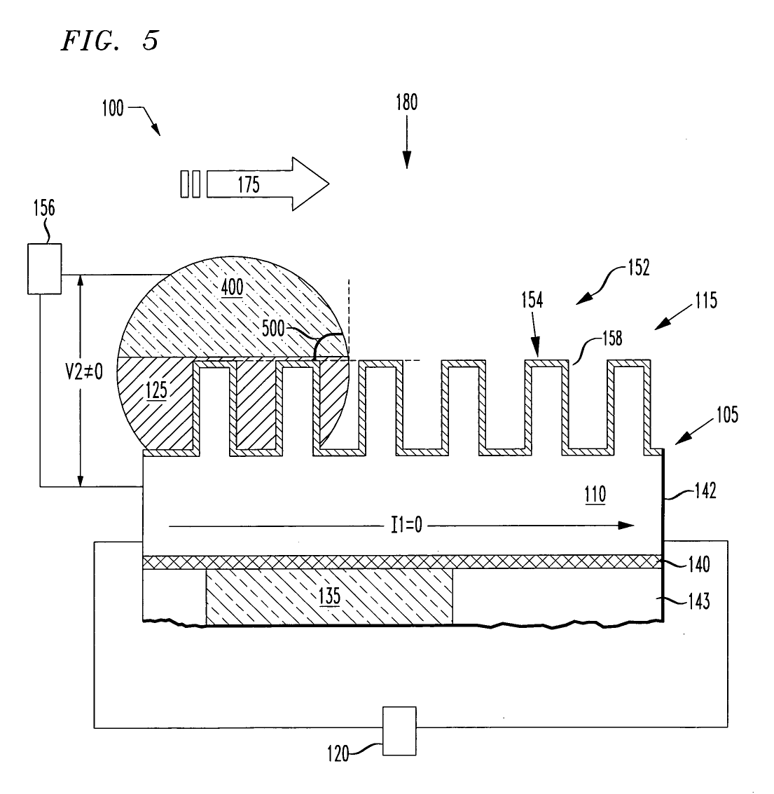

With continuing reference to FIG. 4, FIG. 5 illustrates the device 100 after wetting the intrinsically de-wettable surface 152, by applying a non-zero voltage (V2≠0) between the conductive base layer 110 and the fluid 125, such as discussed in U.S. Patent Applications 2005/0039661 and 2004/0191127. Wetting allows the fluid 125 to penetrate between the fluid-support-structures 115. Accordingly, the fluid 125 is lowered from the tops 154 of the fluid-support-structures 115 to the base layer 110. Under such conditions, a droplet of fluid 125 on the surface 152 can have a contact angle 500 of 90 degrees or less.

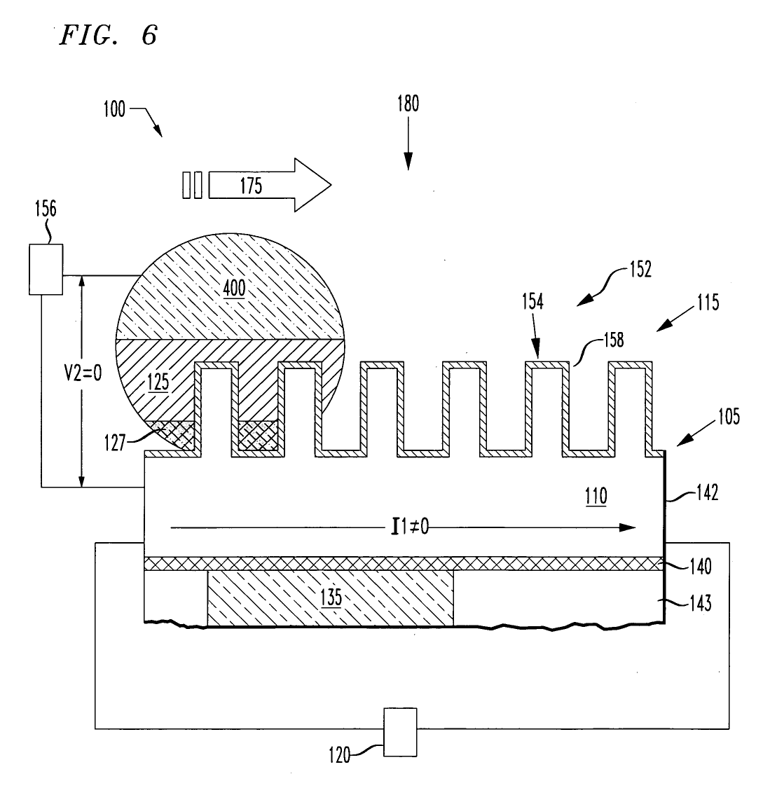

Referring now to FIG. 6, while maintaining reference to FIGS. 4-5, illustrated is the device 100 while raising the fluid 125 to tops 154 of the fluid-support-structures 115. The fluid 125 is raised by converting a portion 127 of the fluid 125 into a vapor when a current (I1) is applied through the base layer 110. Passing a current through the base layer 110 heats the base layer 110, which, in turn, can superheat or film boil the portion of the fluid 127. As noted above, in some cases, the portion of fluid 127 is heated to a temperature above the fluid's standard boiling point. Heating is facilitated when the fluid 125 contacts the base layer 110, such as when the surface 152 is wetted, as described above in the context of FIG. 5.

In other cases, heating the fluid 127 can be accomplished by heating via the fluid-support-structures 115. As discussed above, the fluid-support-structures 115 can be heated by one or both of direct heating, by passing the current through them, or indirect heating, through conductive heat transfer from the heated base layer 110. Heating of the fluid 127 via the fluid-support-structures 115 can be particularly advantageous when the device comprises laterally connected fluid-support-structures such as discussed above and illustrated in FIG. 3. Of course, the fluid 127 can be heated via heating from the base layer 110, the fluid-support-structures 115, or both.

Any of the above-described currents and durations can be used to accomplish superheating or film boiling. In some cases, for example, a pulse of current (I1) of about 100 Amps is applied for about 30 to about 40 ms, across the entire lateral width 130 of the base layer 110. In some instances, it is preferable for the voltage (V2) between the fluid-support-structures 115 and fluid 125 to equal zero during the period that the current (I1) is applied. Likewise, in some instances, it is preferable not to apply the current (I1) through the base layer 110 when the voltage (V2) is applied, as described above in the context of FIG. 5. As further illustrated in FIG. 6, after applying the current (I1), the base layer 110 can be more rapidly cooled by dissipating the heat to a heat buffer 135 that is thermally coupled to the base layer 110.

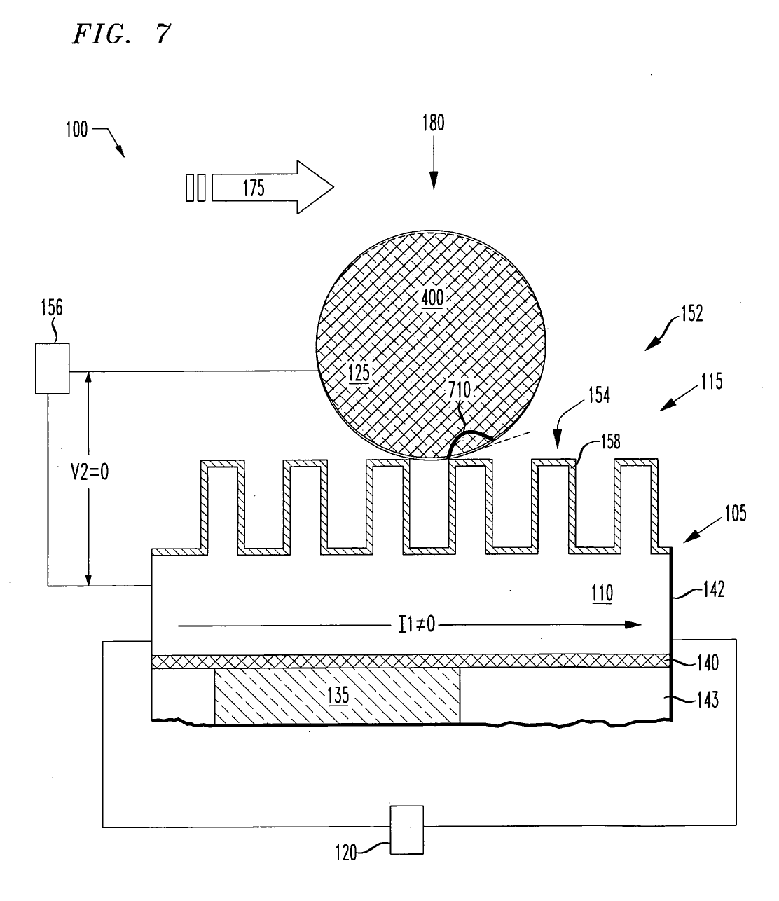

Consequently, as illustrated in FIG. 7, the surface 152 of the device 100 returns to its intrinsically de-wetted state, as reflected by the fluid 125 returning to the tops 154 of the fluid-support-structures 115 such that the droplet has a contact angle 710 of at least about 140 degrees. For example, fluid-support-structures 115 that comprise a coating 158 having high-energy material can be preferred in such cases. The vertical movement of the fluid 125 between the tops 154 of the fluid-support-structure 115 and the base layer 110, such as illustrated in FIGS. 5-6, can be repeated a plurality of times. That is, the fluid 125 can be alternately lowered and raised in a repetitive fashion and the surface 152 thereby made to alternate between wetted and de-wetted states.

Of course, raising the fluid 125 to the tops 154 of the fluid-support-structures 115, as described above, does not necessarily require the application of a voltage (V2) to wet the surface 152. For instance, a surface 152 bearing the fluid-support-structures 115 can be an intrinsically wettable surface. On such a surface 152, the fluid 125 can spontaneously penetrate the fluid-support-structures 115 and contact the base layer 110. Passing the current (I1) through the base layer 110, fluid-support-structures 115, or both, can transiently raise the fluid 125 to the tops 154 of the fluid-support-structures 115. Similar to that discussed above, the fluid 125 can be made to repeatedly move between tops 154 of the fluid-support-structure 115 and the base layer 110, by multiple discrete applications of the current (I1) to convert portions of the fluid 127 into vapor to thereby transiently raise the fluid 125 to the tops 154 of the fluid-support-structures 115.

Some preferred embodiments of the method include mixing two or more different fluids together. For example, as further illustrated in FIGS. 4-6, embodiments of the method can include placing a second fluid 400 adjacent the fluid 125, and raising the fluid 125 and the second fluid 400 between the tops 154 of the fluid-support-structures 115 and the base layer 110, to thereby mix the fluid 125 and second fluid 400 together, as shown in FIG. 7. Mixing can be accomplished by raising and lowering the fluid 125 on a surface 152 that is intrinsically de-wetted, by alternately applying the current (I1) and voltage (V2), as discussed above. Alternatively, mixing can be accomplished by raising and lowering the fluid 125 on a surface 152 that is intrinsically wetted, by intermittently applying the current (I1), as also discussed above. In the latter such embodiments, the fluid 125 and second fluid 400 can be transiently raised to the tops 154 of the fluid-support-structures 115 when the current (I1) is applied, and then allowed to spontaneously penetrate the fluid-support-structures 115 and contact the base layer 110, when the current is turned off.

As illustrated in FIGS. 4-7, the fluid 125 and second fluid 400 can each be droplets on the surface 152 of the substrate 105. In some cases, the fluid 125 is a layer on the substrate surface 152, and the second fluid 400 is a second layer on the layer of fluid 125. The latter may be the case, for example, when the fluid 125 has a higher density than the second fluid 400. In still other cases, the surface 152 comprises an interior surface of a channel, and the fluid 125 and second fluid 400 are inside the channel.

In some preferred embodiments, raising the fluid 125 by superheating or film boiling a portion of the fluid 127, as described above, also increases the fluid's 125 Rayleigh number to above a threshold for convection. Inducing convection in the remaining fluid 125 that is not vaporized facilitates mixing with the second fluid 400. For the purposes of the present invention, the Rayleigh number is defined to be a dimensionless parameter corresponding to the propensity of a fluid to undergo convection for a defined gradient in temperature. The Rayleigh number (Ra) is defined by the following equation: Ra=gαΔTd³/UK, where g is the acceleration of gravity (980 cm²/sec), α is the coefficient of thermal expansion, ΔT is the temperature difference in ° C., d is the layer thickness or droplet diameter in cm, U is the kinematic viscosity of the fluid, and K is the thermal diffusivity of the fluid.

Consider, as an example, a fluid 125 comprising a layer of water. In this case, a equals about 2.06×10⁻⁴K⁻¹, U equals about 0.0101 cm⁻²/sec and K equals about 0.00143 cm⁻²/sec. If a sufficient current (I1) is passed through the base layer 110 to heat the fluid 125 from 20 to 35° C., then Ra is greater than 1708, the threshold for convection for an idealized layer of fluid having a thickness (d) of about 0.2 cm. For a fluid 125 comprising a spherical droplet having a diameter 410 (FIG. 4) of about 2 mm, the threshold value of Ra is expected to be much less than 1708. Accordingly, the Rayleigh number of the droplet of fluid 125 will be above the threshold for convection if the temperature of the fluid 125 is increased by about 15° C. An increase in the temperature of the fluid 125 from about 20° C. to about 200° C. is expected to increase the Rayleigh number of the fluid 125 to at least 10 to 20 times above the threshold for convection.

As also illustrated in FIGS. 5-7, preferred embodiments of the method include moving the fluid 125 laterally over the substrate surface 152 along a predefined direction 175. In still other preferred embodiments, both the fluid 125 and the second fluid 400 are placed on the substrate surface 152, and then moved to a desired location 180 on the substrate. The movement to the desired location 180 can be accomplished while alternately applying the current (I1) and voltage (V2) to cause both the fluid 125 and the second fluid 400 to rise and descend, thereby mixing the fluid 125 and second fluid 400 together while they are both being moved laterally.

Numerous methods can be used to facilitate the lateral movement of the fluid 125. In some cases, when the fluid 125 is in a channel whose interior surface comprises the above-described surface 152, a pressure can be applied to force the fluid 125, or fluids, through the channel. In other cases, movement is facilitated by progressively increasing the applied voltage (V2) in the direction 175 towards the desired location 180. In other instances, movement is facilitated by progressively increasing a contact area between the tops 154 of the fluid-support-structures 115 and the fluid 125 in the direction 175 towards the desired location 180. The movement of fluid on structured surfaces is discussed in further detail in U.S. Patent Application 2004/0191127.

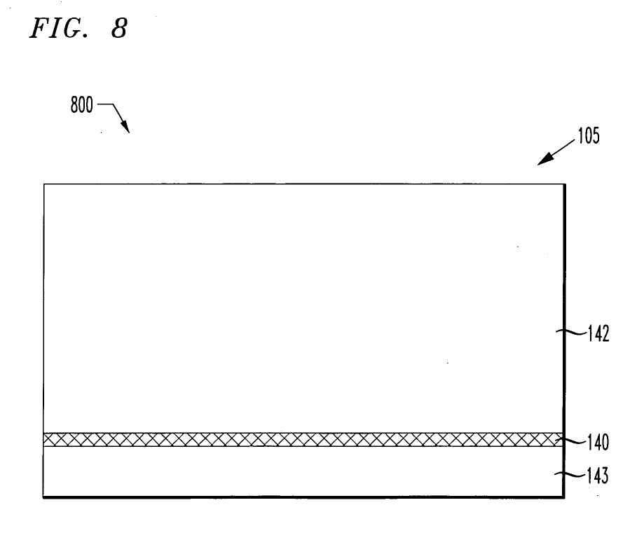

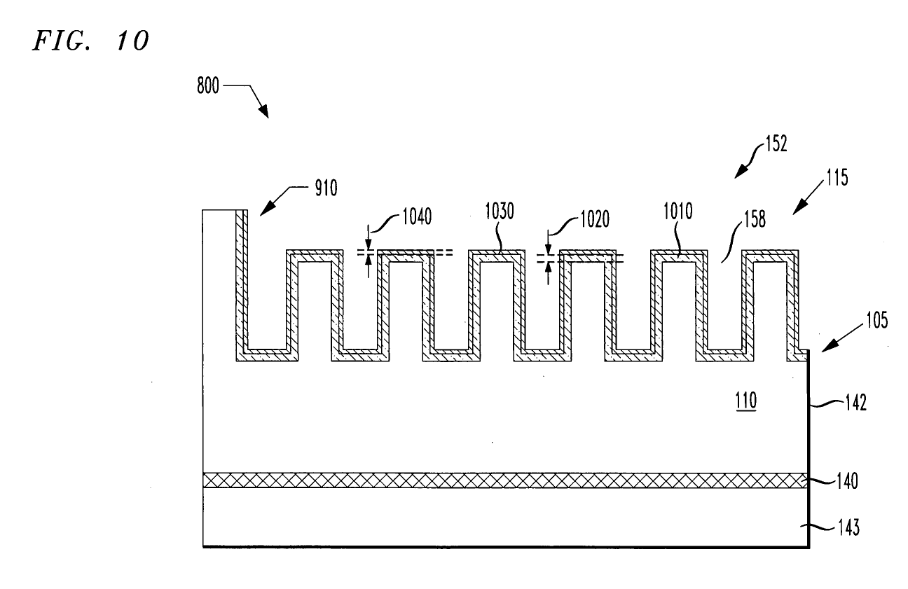

Still another aspect of the present invention is a method of manufacturing a device. FIGS. 8-11 present cross-section views of an exemplary device 800 at selected stages of manufacture. The cross-sectional view of the exemplary device 800 is analogous to that presented in FIG. 1. The same reference numbers are used to depict analogous structures shown in FIGS. 1-7. Any of the above-described embodiments of devices can be manufactured by the method.

Turning now to FIG. 8, while maintaining reference to FIG. 1, shown is the partially-completed device 800 after providing a substrate 105. In some preferred embodiments, the substrate 105 is a planar semiconductor substrate, and more preferably, a silicon-on-insulator (SOI) wafer, having upper and lower electrically conductive layers 142, 143 and an insulating layer 140 therebetween. Of course, in other embodiments, the substrate 105 can comprise a plurality of planar layers made of other types of conventional materials that are suitable for patterning and etching.

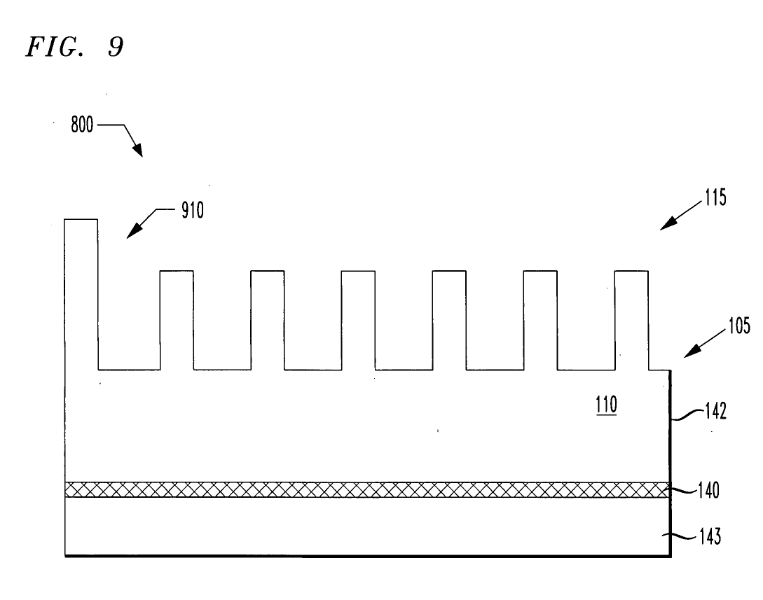

With continuing reference to FIGS. 1 and 8, FIG. 9 presents the partially-completed device 800 after forming fluid-support-structures 115 on a base layer 110 of the substrate 105. In some preferred embodiments, such as shown in FIG. 9, the fluid-support-structures 115 on a base layer 110 are formed from the upper conductive layer 142. Similar to the devices discussed in the context of FIGS. 1-7, each of the sample-support-structures 115 has at least one dimension of about 1 millimeter or less.

The sample-support-structures 115 and base layer 110 can be formed by removing portions of the substrate 105 using any conventional semiconductor patterning and etching procedures well-known to those skilled in the art. Patterning and etching can comprise photolithographic and wet or dry etching procedures, such as deep reactive ion etching. In some embodiments, a channel 910 also is formed in the substrate 105 using similar, and preferably the same, semiconductor patterning and etching procedures used to form the support structures 115 and base layer 110.

With continuing reference to FIGS. 1 and 8-9, FIG. 10 presents the partially-completed device 800 after forming a coating 158 over the base layer 110 and the fluid-support-structures 115. Forming the coating 158 can comprise forming an electrical insulating layer 1010 by conventional thermal oxidation. In some cases, thermal oxidation comprises heating a silicon substrate 105 to a temperature in the range from about 800 to about 1300° C. in the presence of an oxidizing atmosphere such as oxygen and water. In some cases, the electrical insulating layer 1010 has a thickness 1020 of about 1 to about 100 nanometers. Forming the coating 158 can also comprise forming a low-surface-energy layer 1030. For example, a fluorinated polymer, such as polytetrafluoroethylene, can be spin coated over the surface 152 of the substrate 105. In some cases, the low-surface-energy layer 1030 has a thickness 1040 of about 1 to about 100 nanometers.

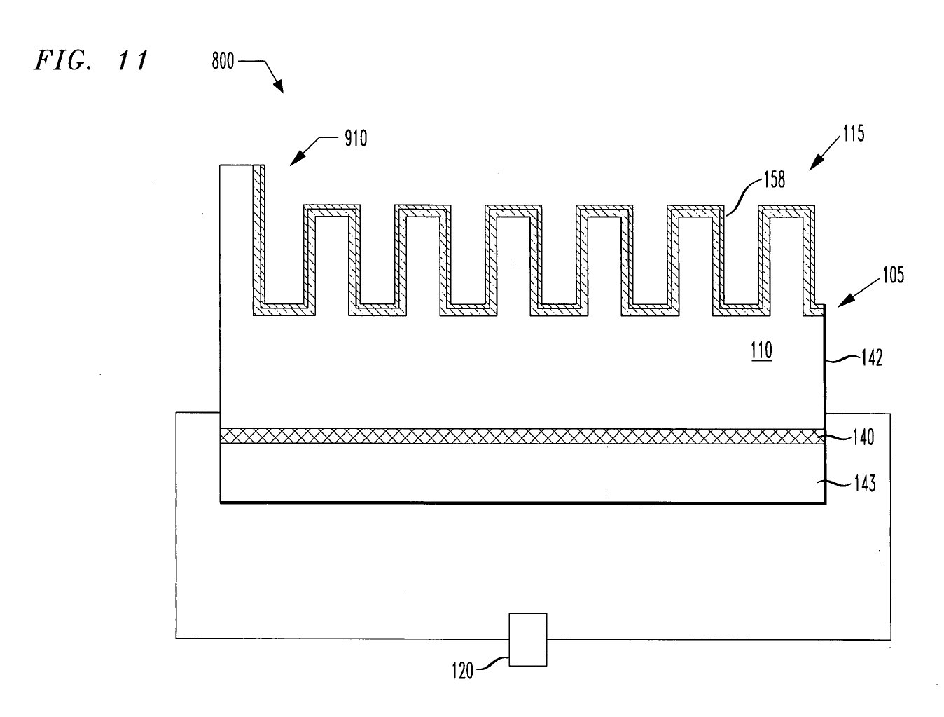

Referring now to FIG. 11, while maintaining reference to FIGS. 1 and 8-10, shown is the partially-completed device 800 after coupling a source of current 120 to the base layer 110. As noted above, the source of current 120 is configured to apply a current to the base layer 110, thereby superheating a fluid locatable over the base layer 110. The source of current 120 can comprise any conventional electrical device capable of delivering the appropriate current to the base layer 110.

Although the present invention has been described in detail, those of ordinary skill in the art should understand that they can make various changes, substitutions and alterations herein without departing from the scope of the invention.

What is claimed is:

1. A device comprising:
a substrate having a base layer, said base layer being connectable to a source of current; and
fluid-support-structures located on said base layer, wherein each of said fluid-support-structures has at least one dimension of about 1 millimeter or less;
wherein said base layer is configured to impart heat to a fluid locatable over said base layer and convert at least a portion of said fluid to a vapor when a current is applied to said base layer.

2. The device of claim 1, wherein said current is generated by applying a voltage across a lateral width of said base layer.

3. The device of claim 1, wherein said converted portion of fluid comprises less than about 10 percent of a total volume of said fluid.

4. The device of claim 1, wherein said base layer has a thermal conductivity in the range of about 150 to about 50 W/m·K at a temperature of from about 100° to about 200° C.

5. The device of claim 1, further including a heat buffer thermally coupled to said base layer.

6. The device of claim 1, wherein said each of said fluid-support-structures and said base layer has a coating comprising an electrical insulator.

7. The device of claim 1, wherein said fluid-support-structures and said base layer both comprise silicon and a coating comprising an electrical insulator of silicon oxide.

8. The device of claim 1, wherein said sample-support-structures and said base layer comprise a low-surface-energy layer.

9. The device of claim 1, wherein said fluid-support-structures and said base layer comprise an upper layer of a silicon-on-insulator substrate.

10. The device of claim 1, wherein each of said fluid-support-structures comprises a post and said one dimension is a lateral thickness of said post.

11. The device of claim 1, wherein each of said fluid-support-structures comprises a cell and said at least one dimension is a lateral thickness of a wall of said cell.

12. A method, comprising:
placing a fluid over a substrate, said substrate having a base layer and fluid-support-structures on said base layer, wherein each of said fluid-support-structures has at least one dimension of about 1 millimeter or less; and
raising said fluid to tops of said fluid-support-structures by applying a current through said base layer, thereby converting at least a portion of said fluid to a vapor.

13. The method of claim 12, further comprising placing a second fluid adjacent to said fluid and raising and lowering said fluid and said second fluid, thereby mixing said fluid and said second fluid together.

14. The method of claim 12, wherein said fluid-support-structures are heated when said current is applied.

15. The method of claim 12, further comprising lowering said fluid from said tops of said fluid-support-structures to said base layer by applying a voltage between said conductive base layer and said fluid.

16. The method of claim 15, further comprises repetitively alternating said lowering and said raising of said fluid.

17. The method of claim 12, wherein converting said portion of said fluid to said vapor comprises producing a superheat explosion.

18. The method of claim 12, wherein converting said portion of said fluid to said vapor comprises producing film boiling.

19. The method of claim 12, further comprises cooling said base layer by dissipating said heat to a heat buffer thermally coupled to said base layer.

20. A method of manufacturing a device, comprising:
removing portions of a substrate to form a base layer and a plurality of fluid-support-structures thereon, each of said fluid-support-structures having at least one dimension of about 1 millimeter or less; and
coupling a source of current to said base layer, said source of current configured to apply a current to said base layer, to thereby convert a portion of a fluid locatable over said base layer into a vapor.
